(19) United States
(12) Patent Application Publication
(10) Pub. No.: US 2016/0361850 A1
(43) Pub. Date: Dec. 15, 2016

(54) MOLDED MEMBER AND METHOD OF MANUFACTURING THE SAME

(71) Applicant: TOYOTA BOSHOKU KABUSHIKI KAISHA, Aichi-ken (JP)

(72) Inventor: Ryo NAKAJIMA, Aichi-ken (JP)

(73) Assignee: TOYOTA BOSHOKU KABUSHIKI KAISHA, Aichi-ken (JP)

(21) Appl. No.: 15/163,958

(22) Filed: May 25, 2016

(30) Foreign Application Priority Data
Jun. 11, 2015 (JP) 2015-118009

(51) Int. Cl. B29C 45/14; B29B 11/04; B29C 65/02; B29C 45/00

(52) U.S. Cl. CPC B29C 45/14; B29C 45/0025; B29B 11/04; B29C 65/02; B29C 2045/14877; B29K 2023/12

(57) ABSTRACT

A molded member includes a base member including fibers, a flattening layer having a flat surface and disposed on one surface of the base member, and a molded part welded on the flat surface of the flattening layer.

### CROSS REFERENCE TO RELATED APPLICATION

This application claims priority from Japanese Patent Application No. 2015-118009 filed on Jun. 11, 2015. The entire contents of the priority application are incorporated herein by reference.

### FIELD OF THE INVENTION

The present disclosure relates to a molded member and a method of manufacturing the molded member.

### BACKGROUND OF THE INVENTION

An example of a molded member has been known as one used in a door trim. A a door trim includes a trim board (a base member) including fibers, and a bracket (a molded part) such as a clip seat that is attached to the trim board with welding.

### SUMMARY OF THE INVENTION

According to the present technology, a molded member includes a base member including fibers, a flattening layer having a flat surface and disposed on one surface of the base member, and a molded part welded on the flat surface of the flattening layer.

### BRIEF DESCRIPTION OF THE DRAWINGS

FIG. 1 is a perspective view illustrating a part of a door trim including a trim board and a bracket that is connected to the trim board according to a first embodiment seen from a vehicular exterior side.

FIG. 2 is a cross-sectional view of a molding device where a pre-board is set.

FIG. 3 is a cross-sectional view of the molding device that is closed and does not include injected melted resin.

FIG. 4 is a cross-sectional view of the molding device that is closed and includes the injected melted resin.

FIG. 5 is a cross-sectional view of the molding device that is opened after a bracket is molded.

FIG. 6 is a cross-sectional view of a connection portion of the base member and the bracket.

FIG. 7 is a cross-sectional view of a thermoplastic resin film according to a second embodiment.

FIG. 8 is a cross-sectional view of a connection portion of a base member and a bracket.

FIG. 9 is a cross-sectional view of a molding device in a flattening layer forming process according to a third embodiment, a thermoplastic resin film and a pre-board being set in the molding device.

### DETAILED DESCRIPTION OF EMBODIMENTS

Products such as vehicles including molded member have been severely required to reduce a weight thereof and a molded member is also required to reduce a weight thereof. To reduce a weight of the molded member, a molded member may include a lightweight base member that is reduced in mass per a unit volume compared to a conventional one.

However, the lightweight base member is likely to have gaps between fibers compared to the conventional one. Therefore, when a molded part is attached to the lightweight base member, a melted material of the molded part is likely to spread through the gaps. Such spread of the material may cause lowering of yield of the molded member and the spread of the material may be less likely to occur with improved methods.

An objective of the present technology is to achieve less occurrence of spread of material in welding a molded part and reduce a weight of a molded member.

### First Embodiment

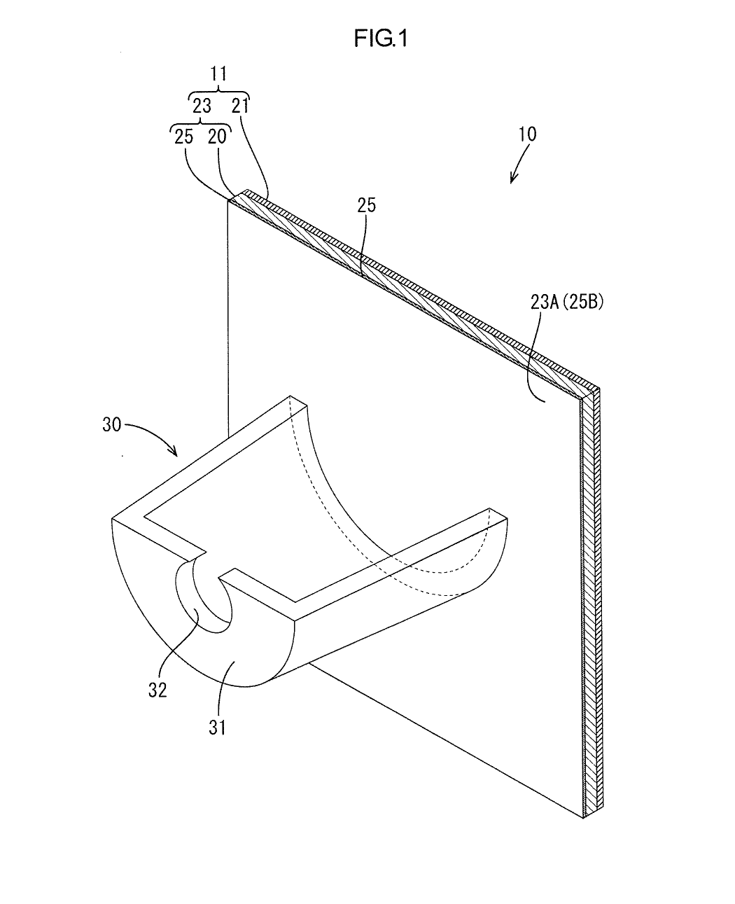

A first embodiment of the present technology will be described with reference to FIGS. 1 to 6. As illustrated in FIG. 1, in this embodiment, a door rim 10 (an example of a molded member) includes a trim board 11 and a bracket 30 (an example of a molded part) such as a clip seat. The bracket 30 is attached to the trim board 11 with welding. The trim board 11 includes multiple brackets 30. Only one bracket 30 is described in each drawing.

As illustrated in FIG. 1, the trim board 11 has a flat plate shape and includes a base member 20 having a vehicular interior side surface facing a vehicular interior side and the vehicular interior side surface is covered with a skin 21. The base member 20 has a rear surface 20B that is opposite from the vehicular interior side surface 20A. The skin 21 is made of synthetic leather, natural leather or fiber and attached to a surface of the base member 20 with adhesive. In this embodiment, a skin attachment process in which the skin 21 is attached to the base member 20 is executed after attachment of a bracket 30, which will be described later. The skin attachment process may be executed at the same time the base member is processed with press molding.

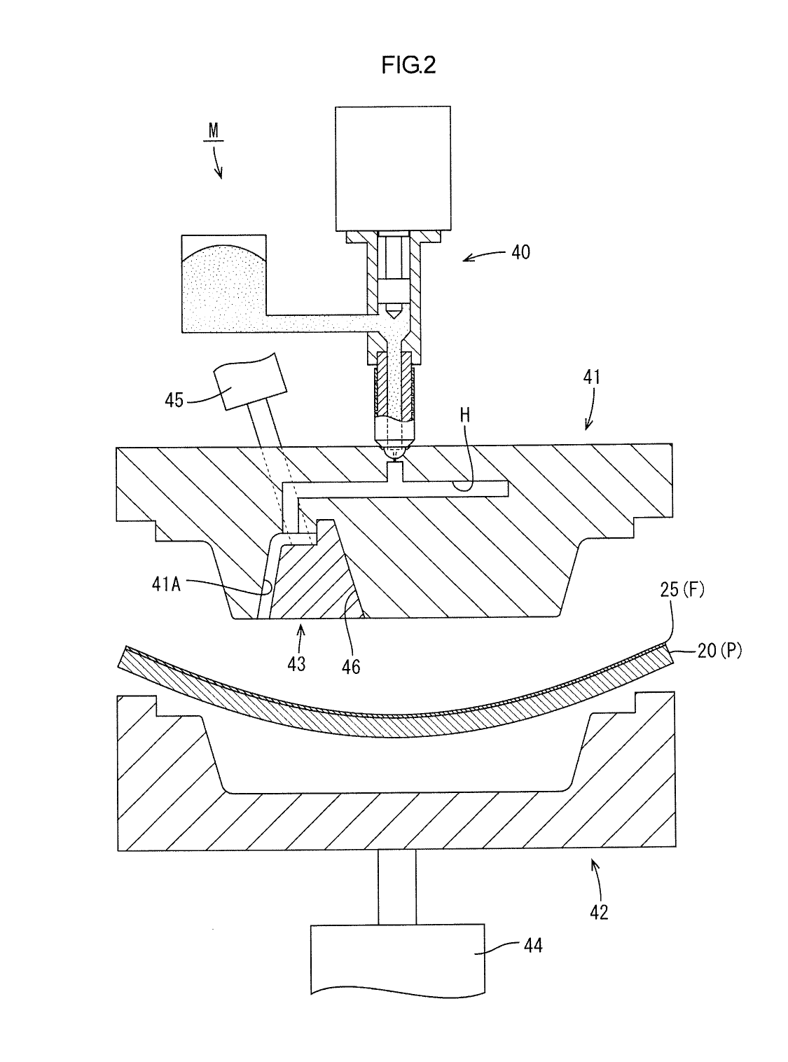

The base member 20 includes woody fiber obtained by weaving wood fiber or bast plant fiber such as kenaf and thermoplastic resin. The base member 20 is formed by immersing the fiber in the thermoplastic resin. As illustrated in FIG. 2, a pre-board P having a mat shape is compressed with press molding to have a density higher than the pre-board. Thus, the base member 20 is formed. In this embodiment, the base member 20 includes kenaf and polypropylene. A conventional base member has a thickness of approximately 2 mm and density of 0.5 g /cm³ or more. The base member 20 has a thickness of approximately 3 mm after the pre-board P is compressed with press molding and the thickness is greater than that of the conventional base member. The base member 20 has density of 0.25 to 0.5 g/cm³. The base member is a lightweight base member. With using such a base member 20, the door trim 10 is effectively reduced in weight and has good rigidity. A ratio of the content of kenaf to the content of polypropylene is approximately 5:5 (mass ratio). That is, a ratio of the content of plant fiber to the content of thermoplastic resin is approximately 5:5. The ratio of the fiber to the thermoplastic resin is not limited thereto. As the ratio of the content of fibers to the content of thermoplastic resin increases, gaps are likely to be generated between fibers, and the present technology is quite effective for the base member having the greater content of fibers because the spread of resin through the gaps are less likely to occur according to the present technology. As the ratio of the content of thermoplastic resin to the content of fiber increases, the fibers are likely to be connected (bonded) to each other sufficiently. Accordingly, the ratio of the content of fiber to the content of thermoplastic resin is preferably from 4:6 to 5.5:4.5.

The base member 20 includes fibers and thermoplastic resin (first thermoplastic resin) that bonds the fibers each other. The thermoplastic resin is a binder that connects the fibers. The thermoplastic resin included in the base member 20 is not particularly limited but may include polyolefin (polypropylene, polyethylene), polyester resin (aliphatic polyester resin such as polylactic acid and polycaprolactone, aromatic polyethylene resin such as polyethylene terephthalate), polystyrene, polyacrylic resin (methacrylate, acrylate), polyamide resin, polycarbonate resin, and polyacetal resin. Only one of the materials may be used or two or more of the materials may be used. Among the above, at least one of polyolefin and polyester resin, and polypropylene is preferably used as the polyolefin. In this embodiment, polypropylene that has a low gravity and is preferable for reducing weight of the base member 20 is used.

As illustrated in FIGS. 1, 3 to 5, the base member 20 includes a flattening layer 25 on the rear surface 20B (one surface, a vehicular exterior surface) thereof. The base member 20 and the flattening layer 25 constitute a trim board main body 23, and the trim board main body 23 and the skin 21 constitute the trim board 11. The base member 20 further includes the bracket 30 that is attached on a rear surface 20B side thereof via the flattening layer 25 with welding. Next, configurations of the bracket 30 and the flattening layer 25 will be described.

The bracket 30 is formed by molding thermoplastic resin (second thermoplastic resin). The thermoplastic resin used for the bracket 30 may not be particularly limited but may include various thermoplastic resin. Polyolefin is preferably used because it is easily used for injection molding and has preferably used for the bracket 30 having good strength. Particularly, polypropylene such as propylene homopolymer, and ethylene-propylene block copolymer is preferable. In this embodiment, polypropylene is used as thermoplastic resin included in the bracket 30.

As illustrated in FIG. 1, the bracket 30 has a shape of substantially a half of cylindrical shape. The cylindrical shape changes its diameter between a basal portion thereof and a distal end portion thereof. The bracket 30 has a large diameter on the rear surface 20B side of the base member 20 of the trim board 11. The bracket 30 includes a wall 31 on a side of the distal end portion thereof and the wall 31 is flat and has a semicircular shape. The wall 31 has a circular hole 32 at an edge of the wall 31. The bracket 30 is fixed to a vehicular panel via a clip that is to be inserted through the circular hole 32 and is a mount portion for mounting the door trim 10 on the vehicular panel.

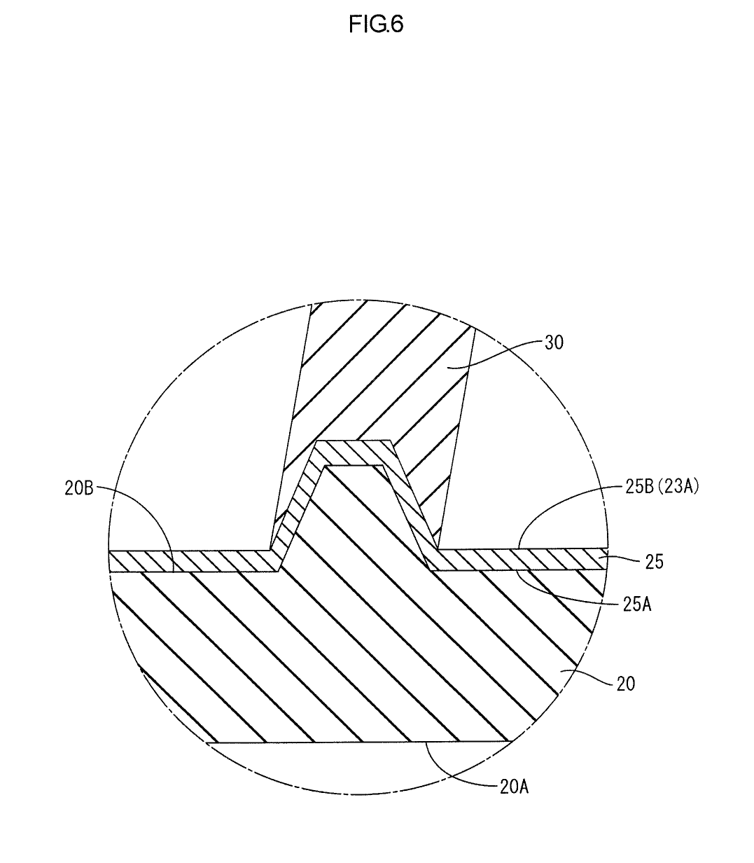

As illustrated in FIG. 6, the flattening layer 25 is constituted by only one layer containing thermoplastic resin (third thermoplastic resin). The thermoplastic resin included in the flattening layer 25 is not particularly limited and may include various kinds. The thermoplastic resin included in the flattening layer 25 may be preferably resin similar to the thermoplastic resin included in the base member 20 (polypropylene in this embodiment) or/and thermoplastic resin included in the bracket 30 (polypropylene in this embodiment), or may be resin that is compatible with such resin to ensure bonding strength between the bracket 30 and the trim board main body 23 including the base member 20. In this embodiment, polypropylene is used as the thermoplastic resin included in the flattening layer 25.

The material of the flattening layer 25 on the side of the front surface 25A that is in contact with the base member 20 enters the base member 20 through the gaps between the fibers. The flattening layer 25 is pressed with a heated plate having a flat pressing surface, and the rear surface 25B that is opposite from the base member 20 side is formed to be a flat surface. The flattening layer 25 has the rear surface 25B having higher smoothness and less roughness than the rear surface 20B of the base member 20. Thus, the trim board main body 23 including the base member 20 has a smooth and flat rear surface 23A. The flattening layer 25 is included on the rear surface 23A of the trim board main body 23 and therefore, the trim board main body 23 has a rear surface 23A side portion having a higher ratio of the content of thermoplastic resin than the base member 20. The trim board main body 23 including the flattening layer 25 and a lightweight base member includes the thermoplastic resin having an amount enough for bonding the bracket 30 on the rear surface 23A side. The trim board main body 23 including the flattening layer 25 includes a greater amount of polypropylene on the rear surface 23A side portion compared to a base member without having the flattening layer 25.

As illustrated in FIG. 2, the flattening layer 25 is made of a thermoplastic resin film F and the thermoplastic resin film F is welded on the pre-board P with heated. Thus, the flattening layer 25 is integrally included in the trim board main body 23 with the base member 20. The thermoplastic resin film F has a constant thickness of approximately 100 μm and is a single layer structure including only one kind of resin. In FIGS. 1 to 6, the thickness of the thermoplastic resin film F and the flattening layer 25 is described with greater thickness than actual size.

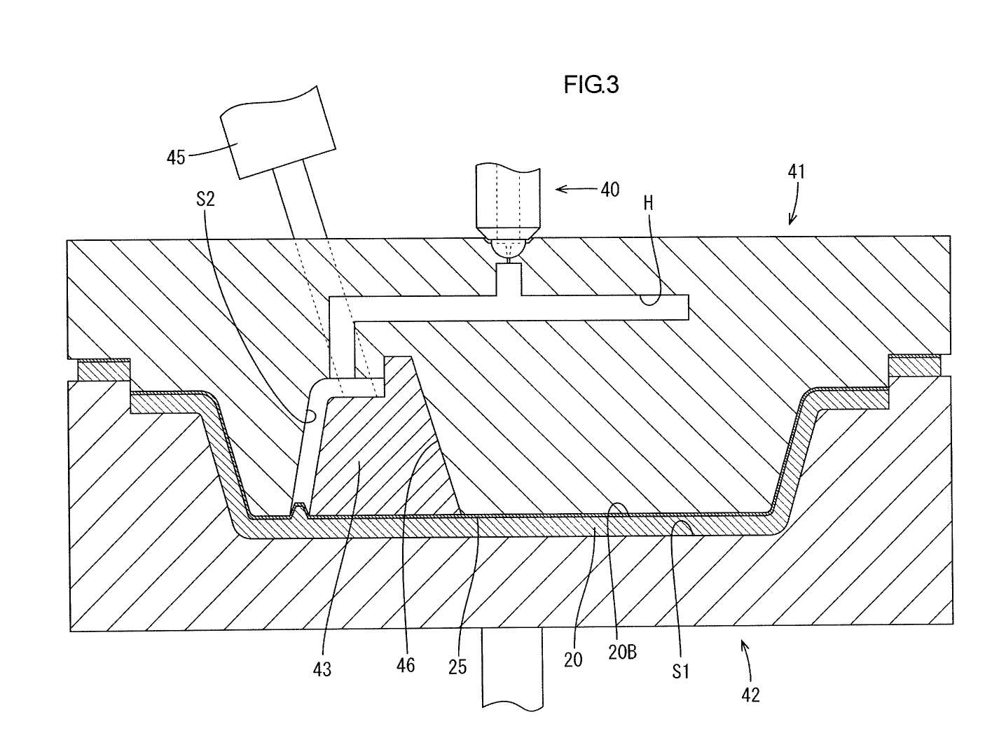

As illustrated in FIGS. 2 and 3, the flattening layer 25 is disposed over an substantially entire area of the rear surface 20B of the base member 20. According to such a configuration, one thermoplastic resin film F provides the flattening layer 25 between each of the brackets 30 and the base member 20. Further, the brackets 30 are collectively formed with molten resin ejected from one nozzle and transferred via a runner connecting mold recesses for the brackets 30. Therefore, resin is less likely to leak from the runner.

Next, a molding device M for molding the trim board main body 23 and the bracket 30 will be described with reference to FIGS. 2 to 5. The molding device M of this embodiment is an injection molding device including an injection unit 40, an upper die 41, a lower die 42, and a sliding die 43.

The injection unit 40 is a screw type unit and is disposed above the upper die 41 in this embodiment. The upper die 41 includes a hot runner H through which melted resin 35 is transferred. The hot runner H is communicated with a bracket molding space S2 for molding each bracket 30 and the melted resin 35 is supplied into each bracket molding space S2 from the injection unit 40 through the hot runner H. A common injection unit 40 is used for supplying the melted resin to the bracket molding spaces S2 and therefore, the melted resin 35 is likely to be ejected into each of the bracket molding spaces S2 with substantially even injection pressure.

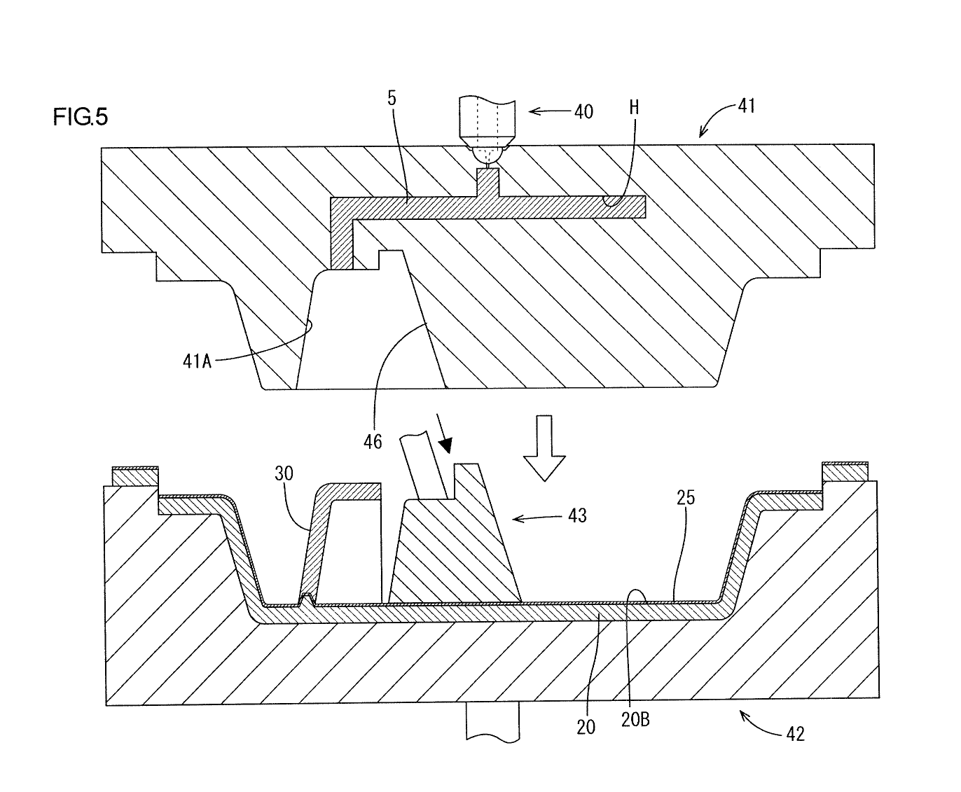

The upper die 41 is fixed to the molding device 4 with appropriate method such as welding, pressure-insertion, or bolts. As illustrated in FIG. 5, the upper die 41 has a projection projecting downward and includes a recess 41A where the sliding die 43 is arranged. The recess 41A is formed in a lower surface of the upper die 41. The lower die 42 is fixed to a driving device 44 via a shaft and is movable vertically between an open position in FIG. 2 and a molding position in FIG. 3. As illustrated in FIG. 3, the lower die 42 has a recess to receive the projection of the upper die 41 in the molding position and is opposite the upper die 41 to be separated therefrom by a space equal to a thickness of the trim board main body 23 including the base member 20 in the molding position.

As illustrated in FIGS. 2 and 3, the molding device M has a base member molding space 51 between the upper die 41 and the lower die 42. The pre-board P and the thermoplastic resin film F are arranged in the base member molding space SI and held and compressed by the upper die 41 and the lower die 42. Thus, the trim board main body 23 including the base member 20 and the flattening layer 25 is formed. The trim board main body 23 includes a flat portion and walls extending outer edges of the flat portion upward. Edge portions of the pre-board P are cut off by shearing force caused by closing of the upper die 41 and the lower die 42. Thus, the base member 20 is molded to have an accurate size.

The sliding die 43 is fixed to the driving device 45 via the shaft and movable obliquely along a surface 46 of the recess 41A between a mold position in FIG. 3 and an open position in FIG. 5. When the sliding die 43 is in the mold position, a lower surface of the sliding die 43 is flush with a lower surface of the upper die 41. The recess 41A has the bracket molding space S2 therein between the upper die 41 and the sliding die 43 that is in the molding position. A size of the bracket molding space S2 is equal to a shape of the bracket 30 to be molded.

The driving devices 44, 45 may be any driving devices such as an actuator activated by an electric motor, an air cylinder, a hydraulic cylinder, an electromagnetic solenoid actuator. The driving device 44, 45 is controlled by a controller, which is not illustrated. The controller detects rotation positions of the electric motor with a pulse encoder mounted in the electric motor and moves the lower die 42 and the sliding die 43 to be in the open position or the mold position according to the detected rotation positions.

Next, a method of manufacturing the door trim 10 will be described with reference to FIGS. 2 to 5. The method of manufacturing the door trim 10 includes a pre-board molding process for molding the pre-board P, a flattening layer forming process for forming the flattening layer 25 on one surface of the pre-board P, a base board molding process for molding the trim board main body 23 including the base member 20 from the pre-board P, and a molded part molding process for integrally molding the bracket 30 with the trim board main body 23 on the rear surface 23A of the trim board main body 23 including the base member 20 and the flattening layer 25.

In the pre-board molding process, a mat obtained by mixing kenaf fiber and polypropylene is heated and molded with pressure. A pressure-molded object is cut into pieces having a predetermined length that is longer than length of the molded base member 20. Thus, a pre-board P of a flat plate is obtained.

In the flattening layer forming process, the thermoplastic resin film F disposed on the one surface of the pre-board P is pressed by a heated plate and the flattening layer 25 is formed on the one surface of the pre-board P. Thus, the flattening layer 25 is formed on the rear surface 20B of the base member 20 and the trim board main body 23 is obtained. The heated plate has a flat pressing surface and heated to a temperature that enables polypropylene contained in the thermoplastic resin film F and the pre-board P to be melted. Therefore, in the flattening layer forming process, a part of the melted thermoplastic resin film F and polypropylene contained in the melted pre-board P are mixed with each other so that the flattening layer 25 is welded on the pre-board P and the one surface of the pre-board P is flattened following the pressing surface of the heated plate.

In the base member molding process, the pre-board P is heated to a temperature that enables to melt and soften polypropylene (approximately 200° C. in this embodiment) and the heated pre-board P is put on the lower die 42 that is in the open position as illustrated in FIG. 2 so that the one surface having the flattening layer 25 faces upward and faces the bracket molding space S2. Then, as illustrated in FIG. 3, the lower die 42 is moved to the molding position and the upper die 41 and the lower die 42 are closed. Then, the edge portions of the pre-board P are cut off by shearing force and the pre-board P is pressed by the surfaces of the upper die 41 and the lower die 42 forming the base member molding space Si and the trim board main body 23 including the base member 20 is obtained. In this process, a portion of the pre-board P corresponding to the bracket molding space S2 is not pressed and therefore, the portion is relatively raised from surroundings thereof as illustrated in FIG. 3. Namely, the portion has low density.

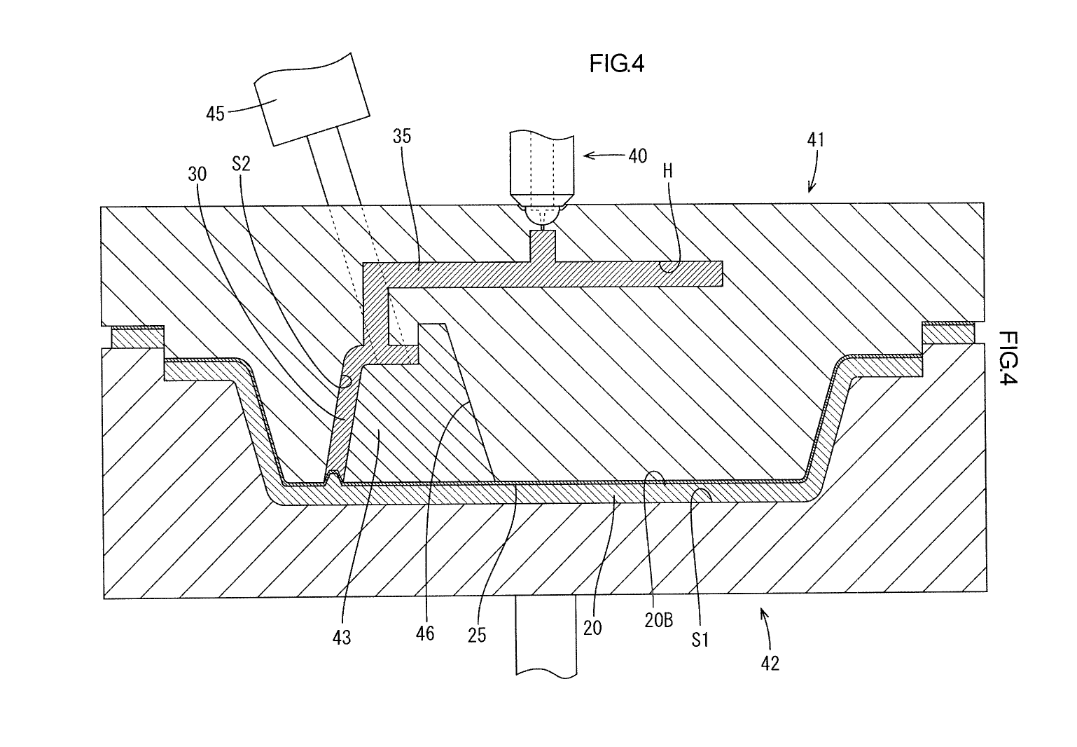

In the molded part molding process, the trim board main body 23 including the base member 20 and the flattening layer 25 is pressed by the upper die 41 and the lower die 42 and the melted resin 35 is injected by the injection unit 40 into each bracket molding space S2 via the hot runner H. The injected melted resin 35 is mixed with the melted polypropylene contained in the flattening layer 25 and a part of softened polypropylene contained in the base member 30 at the raised portion as a unitary part. Accordingly, the bracket molding space S2 is filled with the melted resin 35 and cooled down so that the bracket 30 is molded as illustrated in FIG. 4. Then, as illustrated in FIG. 5, the lower die 42 and the sliding die 43 are moved to the open position and the trim board 11 including the bracket 30 that is fixed to the trim board main body 23 including the base member 20.

Next, operations and advantageous effects of this embodiment will be described. The door trim 10 of this embodiment includes the base member 20 including fiber, the flattening layer 25 that flattening the rear surface 20B of the base member 20, and the bracket 30 that is welded on the rear surface 23A of the trim board main body 23 including the base member 20 via the flattening layer 25. According to this embodiment, the door trim 10 includes the flattening layer 25 and therefore, the melted resin included in the flattening layer 25 enters the gaps between the fibers included in the rear surface 20B side portion of the base member 20. Accordingly, the gaps between the fibers are smaller in the portion of the trim board main body 23 near the rear surface 23A compared to the base member without flattening layer 25. When the bracket 30 is attached to the rear surface 23A of the trim board main body 23 with welding, the melted material for the bracket 30 (the melted resin 35) is less likely to spread through the gaps. Since the spread of the melted resin 35 is less likely to occur, a greater number of brackets 30 can be molded with the melted resin 35 injected from one gate in the molded part molding process. As a result, the number of gates of the molding device M is reduced in manufacturing one door trim 10 and control of opening and closing the gates is easy. If melted resin may spread in the molded part molding process, a defective part may be generated in the molded part (the bracket 30) or the spread resin may be shrunk when solidified. As a result, the design of the door trim 10 may be deteriorated. In this embodiment, such a problem is less likely to be caused. In this embodiment, yield of the door trim 10 is less likely to be lowered with using the lightweight base member and the door trim 10 is reduced in weight.

In this embodiment, the base member 20 is made of thermoplastic resin and fibers that are bonded to each other with the thermoplastic resin. The bracket 30 is made of thermoplastic resin with molding. The flattening layer 25 includes thermoplastic resin at least in a portion near the front surface 25A facing the base member 20 and a portion near the rear surface 25B having the bracket 30. According to such a configuration, resin included in the portion of the flattening layer 25 near the front surface 25A facing the base member 20 is mixed with the thermoplastic resin of the base member, and resin included in the portion of the flattening layer 25 near the rear surface 25B having the bracket 30 is mixed with the thermoplastic resin of the bracket 30. Accordingly, the bonding strength between the bracket 30 and the trim board main body 23 including the base member 20 is effectively ensured.

The bonding strength (vertical tensile strength) between the bracket 30 and the trim board main body 23 including the base member 20 was measured in Example and Comparative Example. A test piece includes the base member 20 and the flattening layer 25 and the bracket 30 is attached to the flattening layer 25 in Example, and a test piece includes no flattening layer 25 and the bracket is directly attached to the base member with welding in Comparative Example. Materials and a molding method of the bracket and the base member in Comparative Example are similar to those of the bracket 30 and the base member 20 in Example except for the flattening layer 25. The bonding strength was measured as follows.

Fifteen test pieces were prepared in each of Example and Comparative Example. Each test piece includes a piece of base member having the flattening layer thereon and one bracket bonded to the flattening layer in Example. Each test piece includes a piece of base member and one bracket bonded thereto in Comparative Example. The base member was fixed to a measurement device and a wall of the bracket was held by a stopper portion of the measurement device. Then, the stopper portion of the measurement device was moved vertically to the rear surface of the base member so as to be away from the rear surface until a bonding portion of the bracket and the flattening layer or the base member was broken, and stress (N) acting on the bonding portion at the time of the breakage was measured.

As a result of the measurement test, the bonding strength obtained in Comparative Example is from 300 to 400 (N) and the bonding strength obtained in Example is from 250 to 600 (N). An average value of the bonding strength in Example is increased by approximately 150 (N) from an average value of the bonding strength in Comparative Example. The bonding strength obtained in Example is equal to or greater than the bonding strength obtained in a conventional product including a base member and a bracket made of one kind of melted resin with injection molding. The bonding strength obtained in Example is effective value for the door trim 10.

According to this embodiment, the method of manufacturing the door trim 10 includes the flattening layer forming process and the molded part molding process. In the flattening layer forming process, the flattening layer 25 is disposed on the rear surface 20B of the base member 20 including fibers to provide a flattened surface and the trim board main body 23 including the base member 20 and the flattening layer 25 is obtained. In the molded part molding process, the upper die 41 and the sliding die 43 having the bracket molding space S2 for molding the bracket 30 are disposed on the rear surface 23A of the trim board main body 23 or the rear surface 25B of the flattening layer 25. The melted resin 35 is injected into the bracket molding space S2 to mold the bracket 30 integrally with the trim board main body 23 including the base member 20 and the flattening layer 25. When the bracket is molded integrally with the base member with injection molding, the melted resin is likely to spread into a space between the base member and the dies (an upper die and a sliding die) due to the injection pressure. In this embodiment, the flattening layer 25 is disposed on the base member 20 and the trim board main body 23 is obtained in the flattening layer forming process prior to the molded part molding process. Therefore, a gap is less likely to be generated between the trim board main body 23 and the upper die 42 and the sliding die 43, and the melted resin 35 is less likely to spread into a space between the trim board main body 23 and the dies.

### Modification of First Embodiment

In this modification, a base member has a configuration different from that of the first embodiment.

In this modification, the base member may include a foaming agent in addition to kenaf and polypropylene. The foaming agent included in the base member foams or is expanded when heated at a certain temperature. The base member including such a foaming agent has a density lower than a base member without including the foaming agent and is a so-called lightweight base member. With such a base member, the door trim is effectively reduced in weight and increased in rigidity. The base member includes gaps where the foaming agents foam and resin may spread into the gaps near the flattening layer in molding the bracket. In this modification, the gaps are filled with the flattening layer and the spread of the resin is less likely to occur.

### Second Embodiment

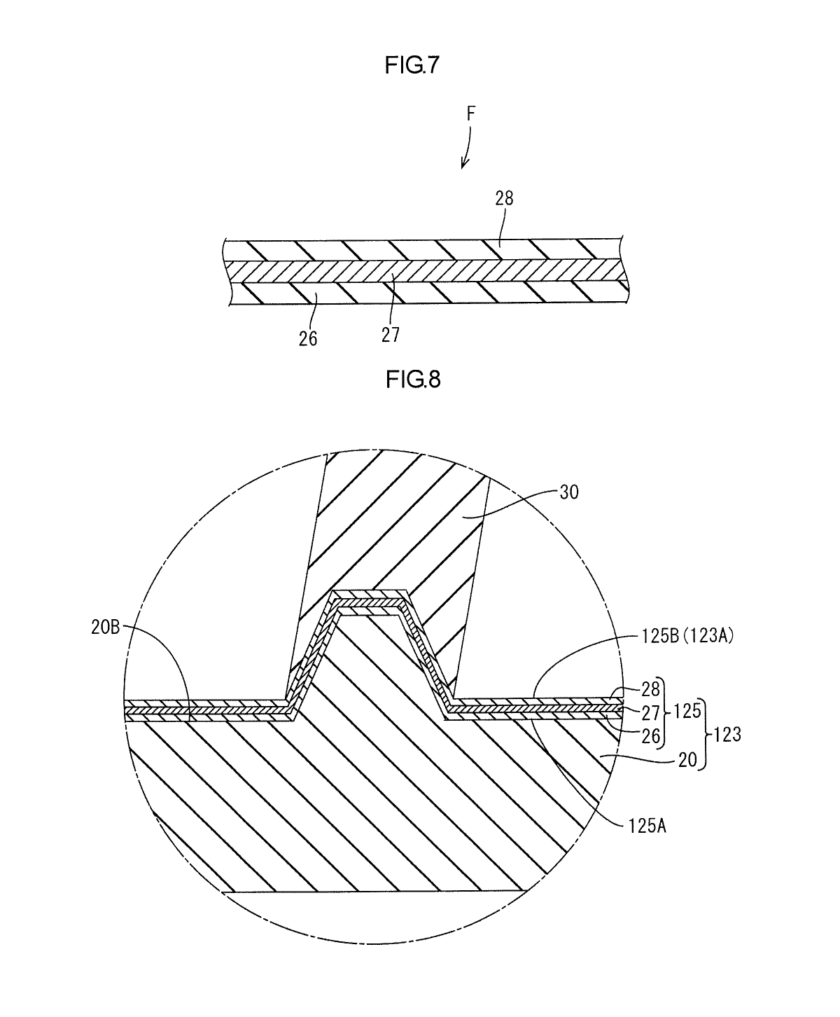

A second embodiment according to the present technology will be described with reference to FIGS. 7 and 8. The parts same as those in the above embodiment are provided with the same numbers or symbols and will not be described. This embodiment is different from the first embodiment in configurations of a flattening layer 125.

The flattening layer 125 includes a base member side layer 26, a molded part side layer 28, and an intermediate layer 27 between the base member side layer 26 and the molded part side layer 28. The base member side layer 26 faces the base member 20 and the bracket 30 is attached to the molded part side layer 28. The intermediate layer 27 includes thermoplastic resin (fourth thermoplastic resin) having a melting point higher than that of the base member side layer 26 and the molded part side layer 28. In this embodiment, the flattening layer 125 includes the base member side layer 26 including the third thermoplastic resin, the intermediate layer 27 including the fourth thermoplastic resin, and the molded part side layer 28 including the third thermoplastic resin. The three layers are layered in this order.

The thermoplastic resin included in each of the layers 26, 27, 28 of the flattening layer 125 is not limited and may be various kinds of resin. The third thermoplastic resin included in the base member side layer 26 and the molded part side layer 28 is preferably a same kind of resin as the thermoplastic resin included in the base member 20 (polypropylene in this embodiment) and the thermoplastic resin included in the bracket 30 (polypropylene in this embodiment) or the resin that is compatible with the thermoplastic resin included in the base member 20 and that in the bracket 30 (polypropylene). Accordingly, the bonding strength between the bracket 30 and the base member 20 is ensured. In this embodiment, polypropylene is used as the third thermoplastic resin.

The fourth thermoplastic resin included in the intermediate layer 27 preferably has a melting point higher than the temperature of the heated pre-board in the base member molding process or/and the temperature of the melted resin 35 injected in the molded part molding process. According to such a configuration, the flattening layer 125 keeps its shape during the molded part molding process. In this embodiment, polyamide is used the fourth thermoplastic resin and polyamide has a melting point higher than that of polypropylene (the first thermoplastic resin, the second thermoplastic resin, the third thermoplastic resin).

With the flattening layer 125, polypropylene included in the base member side layer 26 enters gaps between the fibers included in the base member 20 and also polypropylene included in the molded part side layer is pressed by a heated plate having a flat pressing surface and provides a flat surface. Further, the flattening layer 125 includes the intermediate layer 27 between the base member side layer 26 and the molded part side layer 28 and the intermediate layer 27 is not melted in the base member molding process and the molded part molding process. Therefore, a through hole is less likely to be formed through the whole layers. With the flattening layer 125, the molded part side layer 28 has a flat surface having less roughness than the rear surface 20B of the base member, and the flattening layer 125 is configured to be less deformable. The flattening layer 125 and the base member 20 constitute a trim board main body 123 and the trim board main body 123 has a rear surface 123A that is flat.

The thermoplastic resin film F in FIG. 7 is attached to the pre-board P with welding with heated at a predetermined temperature that is lower than the melting point of the fourth thermoplastic resin and the flattening layer 125 is integrally formed with the base member 20. The thermoplastic resin film F has a constant thickness of approximately from 100 μm to 300 μm and includes three layers. In FIG. 8, the flattening layer 125 is described with a greater thickness than the actual one.

The flattening layer 125 prevents external air containing water or moisture from entering the base member 20 through the rear surface 20B of the base member 20 and functions as an air stopper. Mainly, the intermediate layer 27 included in the flattening layer 125 prevents external air from entering the base member 20. In the base member 20 including natural fiber (particularly fibers of plant), the fibers may be corroded due to the moisture. However, in this embodiment, the flattening layer 125 functions as the air stopper and stops flow of air. Accordingly, corrosion of the fibers is less likely to occur. The flattening layer consists of multiple layers and the flattening layer easily includes a functional layer having a desired function. Accordingly, the door trim 10 has improved properties and quality.

In this embodiment, the flattening layer 125 includes the base member side layer 26 including a front surface 125A facing the base member 20 and the molded part side layer 28 including a rear surface 125B where the bracket 30 is attached. At least the base member side layer 26 and the molded part side layer 28 include the thermoplastic resin. According to such a configuration, the resin included in the base member side layer 26 of the flattening layer 125 is partially mixed with the thermoplastic resin of the base member 20, and the resin included in the molded part side layer 28 of the flattening layer 125 is partially mixed with the thermoplastic resin of the bracket 30. Thus, the bonding strength between the bracket 30 and the base member 20 is ensured. In this embodiment, the injected melted resin 35 is blocked by the intermediate layer 27 of the flattening layer 125 and is not mixed with polypropylene included in the base member 20. However, the flattening layer 125 functions as an adhesive layer between the melted resin 35 and the base member 20 and the flattening layer 125 is bonded to the base member 20 and the bracket 30. Therefore, the bonding strength between the bracket 30 and the base member 20 is effectively ensured.

In this embodiment, if the base member side layer 26 and the molded part side layer 28 included in the flattening layer 125 may be melted and deformed, the flattening layer 125 keeps its shape because it includes the intermediate layer 27. Accordingly, the trim board main body 123 including the base member 20 keeps the flat rear surface 123A where the bracket 30 is welded. Therefore, when the bracket 30 is attached to the rear surface 123A of the trim board main body 123 with welding, melted material of the bracket 30 is less likely to spread into the gaps in the base member 20.

### Third Embodiment

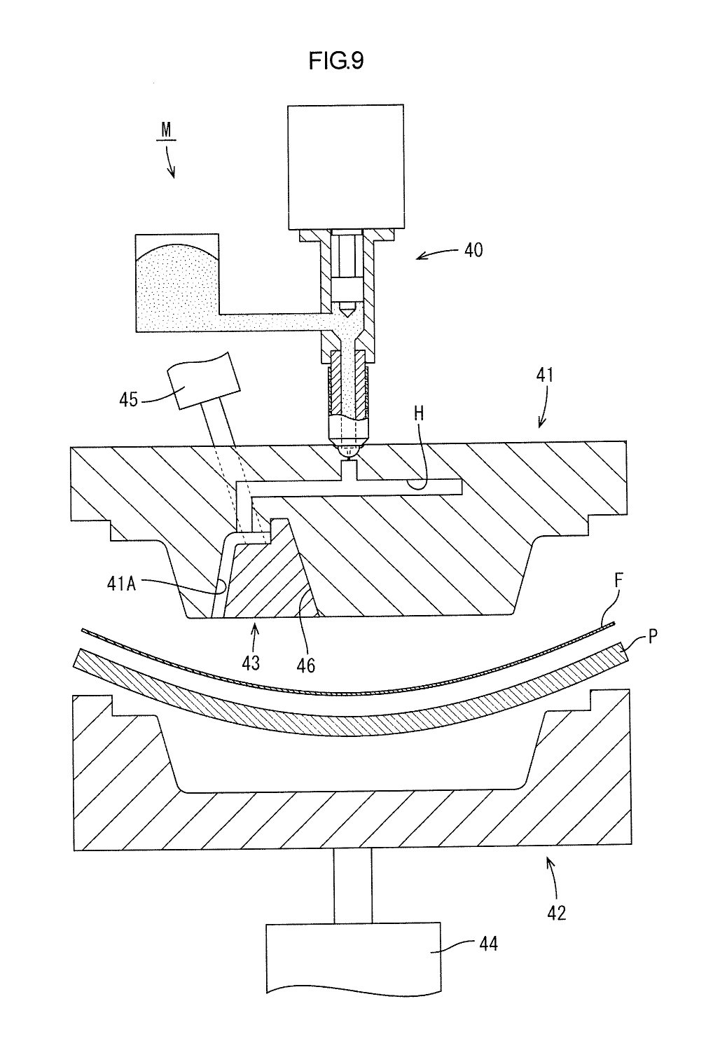

A third embodiment will be described with reference to FIG. 9. The parts same as those in the above embodiments are provided with the same numbers or symbols and will not be described. This embodiment is different from the above embodiments in the flattening layer forming process.

A method of producing a door trim 10 according to this embodiment includes the pre-board molding process in which the pre-board P is molded, a flattening layer and base member molding process, and the molded part molding process. In the flattening layer and base member molding process, the flattening layer forming process and the base member forming process are carried out at the same time. Namely, the forming of the flattening layer 25, 125 on one surface of the pre-board P and the molding of the trim board main body 23, 123 including the base member 20 and the flattening layer 25, 125 are carried out in one step. In the molded part molding process, the bracket 30 is molded integrally with the trim board main body 23, 123.

As illustrated in FIG. 9, in the flattening layer and base member molding process, the thermoplastic resin film F is disposed on a rear surface of the pre-board P and the base member molding process described in the first embodiment is carried out. Then, the base member 20 is molded and the flattening layer 25, 125 is formed on the rear surface 20B of the base member 20 at the same time. Accordingly, the trim board main body 23, 123 is formed. Other processes are same as those in the first embodiment and will not be described.

### Other Embodiments

The present technology is not limited to the description as described above with reference to the drawings. For example, the present technology may include following embodiments.

(1) The fiber used for the base member is not necessarily wood fiber or bast plant fiber but may be any other fibers. The base member may have a density other than that of the above embodiments.

(2) Liquid resin may be disposed over on surface of the base member as the flattening layer.

(3) The resin included in each of the base member, the bracket, and the flattening layer is a same kind of thermoplastic resin (polypropylene) in the above embodiments. However, the resin included in each of the components may be different.

(4) In the above embodiments, the pre-board is molded to the base member after the mat member is molded to the pre-board in the base member molding process. The mat member may be molded directly to the base member in the base member molding process, and the flattening layer may be formed on the mat member.

(5) In the above embodiments, the flattening layer forming process is executed before or at the same time the base member molding process. The flattening layer forming process may be executed at least before the molded part molding process. The order of executing the processes may be altered as necessary.

(6) The base member molding process and the molded part molding process may be executed in different devices.

(7) The molded member may be applied to vehicular components other than the door trim such as a quarter trim or a pillar garish or building materials.

1. A molded member comprising:
a base member including fibers;
a flattening layer having a flat surface and disposed on one surface of the base member; and
a molded part welded on the flat surface of the flattening layer.

2. The molded member according to claim 1, wherein
the base member includes the fibers and first thermoplastic resin, the fibers are bonded to each other with the first thermoplastic resin,
the molded part is made of second thermoplastic resin, and
the flattening layer has a base member side portion facing the base member and a molded part side portion where the molded part is welded, and at least the base member side portion and the molded part side portion include third thermoplastic resin.

3. The molded member according to claim 2, wherein
the flattening layer includes a base member side layer, a molded part side layer, and an intermediate layer,
the base member side layer is the base member side portion,
the molded part side layer is the molded part side portion, and
the intermediate layer is disposed between the base member side layer and the molded part side layer and includes fourth thermoplastic resin having a melting point higher than that of the third thermoplastic resin included in the base member side layer and that of the third thermoplastic resin included the molded part side layer.

4. The molded member according to claim 1, wherein the base member has a density that is from 0.25 g/cm³ to 0.5 g/cm³ .

5. The molded member according to claim I, wherein the flattening layer extends over an entire area of the one surface of the base member.

6. The molded member according to claim 1, wherein the base member further includes a foaming agent.

7. The molded member according to claim 2, wherein
the first thermoplastic resin is compatible with the third thermoplastic resin included in the base member side portion and the second thermoplastic resin is compatible with the third thermoplastic resin included in the molded part side portion.

8. The molded member according to claim 2, wherein
each of the first, second, and third thermoplastic resin is polypropylene, and the fourth thermoplastic resin is polyamide.

9. A method of manufacturing a molded member comprising:
forming a flattening layer on one surface of a base member;
placing the base member on an lower die such that the flattening layer faces a molding space of an upper die;
lowering the upper die to hold the base member and the flattening layer between the upper die and the lower die; and
injecting melted resin into the molding space and molding a molded part integrally with the base member.

10. The method according to claim 9, further comprising:
heating the base member and the flattening layer such that thermoplastic resin included in the base member and the flattening layer is softened, wherein
after the injecting, the melted resin in the molding space is mixed with softened thermoplastic resin included in the flattening layer.

11. The method according to claim 9, further comprising:
pressing the flattening layer formed on the one surface of the base member with a heated flat plate such that thermoplastic resin included in the base member and the flattening layer is melted and mixed and a surface of the flattening layer is flat.

12. The method according to claim 9, wherein
the base member includes first thermoplastic resin,
the melted resin is second thermoplastic resin, and
forming the flattening layer includes forming three layers including a base member side layer facing the base member, a molded part side layer where the molded part is welded, and an intermediate layer between the base member side layer and the molded part side layer, the base member side layer and the molded part side layer include third thermoplastic resin, and the intermediate layer includes fourth thermoplastic resin having a melting point higher than that of the third thermoplastic resin included in the base member side layer and that of the third thermoplastic resin included the molded part side layer.

13. The method according to claim 12, wherein
the heating includes heating the base member and the flattening layer including the three layers at a temperature lower than the melting point of the fourth thermoplastic resin.
